(19) United States
(12) Patent Application Publication
(10) Pub. No.: US 2026/0134444 A1
(43) Pub. Date: May 14, 2026

(54) METHODS AND SYSTEMS FOR DETERMINING A REPRESENTATION OF A NODE ASSOCIATED WITH A GRAPH

(71) Applicant: MASTERCARD INTERNATIONAL INCORPORATED, PURCHASE, NY (US)

(72) Inventors: Vaibhav Kesri, Delhi (IN); Awanish Kumar, Lucknow (IN); Chengxi Li, Greenwich, CT (US); Maneet Singh, New Delhi (IN); Soumyadeep Ghosh, Gurgaon (IN); Tyler Mey, St Louis, MO (US)

(21) Appl. No.: 18/946,905

(22) Filed: Nov. 13, 2024

(51) Int. Cl. G06Q 30/0201; G06F 16/901; G06F 16/906

(52) U.S. Cl. CPC G06Q 30/0201; G06F 16/2246; G06F 16/9024; G06F 16/906

(57) ABSTRACT

Methods and systems for determining a representation of a node associated with a graph are disclosed. The method performed by the server system includes accessing a multi-partite sub-graph, including a central node connected with leaf nodes through paths. The method includes extracting a central node feature set associated with the central node and a leaf node feature set associated with each leaf node of the leaf nodes. The method includes determining, by a ML model, a first node representation for the central node based on a distinct relation type, the central node feature set, and the leaf node feature set. The method includes determining a second node representation for the central node based on concatenating individual path feature vectors of each path. The method includes determining a final node representation for the central node based, at least in part, on the first node representation and the second node representation.

### TECHNICAL FIELD

The present disclosure relates to artificial intelligence-based processing systems and, more particularly, to electronic methods and complex processing systems for determining a representation of a node associated with a graph.

### BACKGROUND

Data plays a critical role in decision-making by offering comprehensive insights and reducing uncertainty. With access to vast amounts of data, organizations can better understand long-term trends and patterns. The data enables organizations to perform accurate forecasting and strategic planning, as decisions are based on data-driven insights. The data also improves personalization efforts, allowing organizations to tailor experiences and services to individual preferences at a scale. In various examples, the data may include, but is not limited to, transaction data, health care data, social media data, and the like.

The transaction data represents records of exchanges between cardholders and businesses. Such transaction data captures essential details like transaction amount, date, merchant, location, and the like. Financial institutions utilize the transaction data to understand the spending habits of a cardholder, provide credit scores to the cardholder, forecast the revenues of the financial institutions, and the like. The healthcare data refers to information related to patients, their health conditions, medical treatments, and healthcare services. Healthcare providers utilize the healthcare data for various purposes, such as predicting diseases, identifying patient outcomes, evaluating treatment effectiveness, and the like. The social media data refers to the vast amount of information generated and shared on various social media platforms. The social media data helps identify trending topics, understand the sentiments of the public regarding an event, and evaluate the performance of the content shared across social media platforms.

Conventionally, the data is stored in tabular formats, and its complexity can become overwhelming when high-dimensional data is analyzed to draw insights from it. The tabular format of the data fails to capture the relation between various entities present in the data, thereby limiting the capability of a down-stream task to identify anomalies that often involve subtle patterns and interactions. In various examples, the anomalies may include, but are not limited to, fraud, disease, trends, and the like. Further, the tabular format of data lacks the flexibility to represent evolving connections or interactions between the various entities.

Thus, a technological need exists for improved methods and systems for capturing the subtle patterns and interactions between the various entities present in the data.

### SUMMARY

Various embodiments of the present disclosure provide methods and systems for determining a representation of a node associated with a graph.

In an embodiment, a computer-implemented method for determining a representation of a node associated with a graph is disclosed. The computer-implemented method performed by a server system includes accessing a multi-partite sub-graph from a database associated with the server system. The multi-partite sub-graph includes a central node connected with one or more leaf nodes through one or more paths. The central node belongs to a particular node set representing a particular entity set, and the one or more leaf nodes belong to a distinct node set representing a distinct entity set. Each path is associated with a distinct relation type. The computer-implemented method further includes extracting a central node feature set associated with the central node and a leaf node feature set associated with each leaf node of the one or more leaf nodes from the multi-partite sub-graph. Further, the computer-implemented method includes determining, by a Machine Learning (ML) model associated with the server system, a first node representation for the central node based, at least in part, on the distinct relation type of each path, the central node feature set and the leaf node feature set. Furthermore, the computer-implemented method includes determining a second node representation for the central node based, at least in part, on concatenating individual path feature vectors of each path. Additionally, the computer-implemented method includes determining a final node representation for the central node based, at least in part, on the first node representation and the second node representation.

In another embodiment, a server system is disclosed. The server system includes a communication interface and a memory including executable instructions. The server system also includes a processor that is communicably coupled to the memory. The processor is configured to execute the instructions to cause the server system, at least in part, to access a sorted postal code list from a database associated with the server system. Further, the server system is caused to access a multi-partite sub-graph from a database associated with the server system. The multi-partite sub-graph includes a central node connected with one or more leaf nodes through one or more paths. The central node belongs to a particular node set representing a particular entity set, and the one or more leaf nodes belong to a distinct node set representing a distinct entity set. Each path is associated with a distinct relation type. Further, the server system is caused to extract a central node feature set associated with the central node and a leaf node feature set associated with each leaf node of the one or more leaf nodes from the multi-partite sub-graph. Furthermore, the server system is caused to determine, by a Machine Learning (ML) model associated with the server system, a first node representation for the central node based, at least in part, on the distinct relation type of each path, the central node feature set, and the leaf node feature set. Moreover, the server system is caused to determine a second node representation for the central node based, at least in part, on concatenating individual path feature vectors of each path. Additionally, the server system is caused to determine a final node representation for the central node based, at least in part, on the first node representation and the second node representation.

In yet another embodiment, a non-transitory computer-readable storage medium is disclosed. The non-transitory computer-readable storage medium includes computer-executable instructions that, when executed by at least a processor of a server system, cause the server system to perform a method. The method includes accessing a multi-partite sub-graph from a database associated with the server system. The multi-partite sub-graph includes a central node connected with one or more leaf nodes through one or more paths. The central node belonging to a particular node set represents a particular entity set, and the one or more leaf nodes belonging to a distinct node set represent a distinct entity set, each path is associated with a distinct relation type. The method further includes extracting a central node feature set associated with the central node and a leaf node feature set associated with each leaf node of the one or more leaf nodes from the multi-partite sub-graph. Moreover, the method includes determining, by a Machine Learning (ML) model associated with the server system, a first node representation for the central node based, at least in part, on the distinct relation type of each path, the central node feature set and the leaf node feature set. Additionally, the method includes determining a second node representation for the central node based, at least in part, on concatenating individual path feature vectors of each path. Also, the method includes determining a final node representation for the central node based, at least in part, on the first node representation and the second node representation.

The foregoing summary is illustrative only and is not intended to be in any way limiting. In addition to the illustrative aspects, embodiments, and features described above, further aspects, embodiments, and features will become apparent by referencing the drawings and the following detailed description.

### BRIEF DESCRIPTION OF THE FIGURES

For a more complete understanding of example embodiments of the present technology, reference is now made to the following descriptions taken in connection with the accompanying drawings in which:

FIG. 1 illustrates a schematic representation of an environment related to at least some example embodiments of the present disclosure;

FIG. 2 illustrates a simplified block diagram of a server system, in accordance with an embodiment of the present disclosure;

FIG. 3 illustrates a schematic representation of a multi-partite sub-graph, in accordance with an embodiment of the present disclosure;

FIG. 4 illustrates a schematic representation of an architecture for determining a representation of a node associated with a graph, in accordance with an embodiment of the present disclosure;

FIG. 5 illustrates a process flow diagram depicting a method for determining a representation for the node, in accordance with an embodiment of the present disclosure;

FIG. 6 illustrates a simplified block diagram of an acquirer server, in accordance with an embodiment of the present disclosure;

FIG. 7 illustrates a simplified block diagram of an issuer server, in accordance with an embodiment of the present disclosure; and

FIG. 8 illustrates a simplified block diagram of the payment server, in accordance with an embodiment of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Reference in this specification to “one embodiment” or “an embodiment” means that a particular feature, structure, or characteristic described in connection with the embodiment is included in at least one embodiment of the present disclosure. The appearances of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

Embodiments of the present disclosure may be embodied as an apparatus, a system, a method, or a computer program product. Accordingly, embodiments of the present disclosure may take the form of an entire hardware embodiment, an entire software embodiment (including firmware, resident software, micro-code, etc.), or an embodiment combining software and hardware aspects that may all generally be referred to herein as a “circuit”, “engine”, “module”, or “system”. Furthermore, aspects of the present disclosure may take the form of a computer program product embodied in one or more computer-readable storage media having computer-readable program code embodied thereon.

Unless otherwise explicitly stated, articles such as “a” or “an” should generally be interpreted to include one or more described items. Accordingly, phrases such as “a server system configured to” are intended to include one or more recited server systems/processors. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C. The same holds true for the use of definite articles used to introduce embodiment recitations. In addition, even if a specific number of an introduced embodiment recitation is explicitly recited, those skilled in the art will recognize that such recitation should typically be interpreted to mean at least the recited number (e.g., the bare recitation of “two recitations” without other modifiers, typically means at least two recitations or two or more recitations).

The terms “account holder”, “user”, “cardholder”, “consumer”, and “buyer” are used interchangeably throughout the description and refer to a person who has a payment account or a payment card (e.g., credit card, debit card, etc.) associated with the payment account, that will be used by them at a merchant to perform a payment transaction. The payment account may be opened via an issuing bank or an issuer server.

The term “merchant”, used throughout the description, generally refers to a seller, a retailer, a purchase location, an organization, or any other entity that is in the business of selling goods or providing services, and it can refer to either a single business location or a chain of business locations of the same entity.

The terms “payment network” and “card network” are used interchangeably throughout the description and refer to a network or collection of systems used for the transfer of funds through the use of cash substitutes. Payment networks may use a variety of protocols and procedures in order to process the transfer of money for various types of transactions. Payment networks are companies that connect an issuing bank with an acquiring bank to facilitate online payment. Transactions that may be performed via a payment network may include product or service purchases, credit purchases, debit transactions, fund transfers, account withdrawals, etc. Payment networks may be configured to perform transactions via cash substitutes that may include payment cards, letters of credit, checks, financial accounts, etc. Examples of networks or systems configured to perform or function as payment networks include those operated by payment processors.

The term “payment card”, used throughout the description, refers to a physical or virtual card linked with a financial or payment account that may be presented to a merchant or any such facility to fund a financial transaction via the associated payment account. Examples of the payment cards include, but are not limited to, debit cards, credit cards, prepaid cards, virtual payment numbers, virtual card numbers, forex cards, charge cards, e-wallet cards, and stored-value cards. The payment card may be a physical card that may be presented to the merchant for funding the payment. Alternatively, or additionally, the payment card may be embodied in the form of data stored in a user device, where the data is associated with a payment account such that the data can be used to process the financial transaction between the payment account and a merchant's financial account.

The term “payment account”, used throughout the description, refers to a financial account that is used to fund a financial transaction. Examples of the financial account include, but are not limited to, a savings account, a credit account, a checking account, and a virtual payment account. The financial account may be associated with an entity such as an individual person, a family, a commercial entity, a company, a corporation, a governmental entity, a non-profit organization, and the like. In some scenarios, the financial account may be a virtual or temporary payment account that can be mapped or linked to a primary financial account, such as those accounts managed by payment wallet service providers, and the like.

The terms “payment transaction”, “financial transaction”, “event”, and “transaction” are used interchangeably throughout the description and refer to a transaction or transfer of payment of a certain amount being initiated by the cardholder. More specifically, they refer to electronic financial transactions including, for example, online payment, payment at a terminal (e.g., Point of Sale (POS) terminal), and the like. Generally, a payment transaction is performed between two entities, such as a buyer and a seller. It is to be noted that a payment transaction is followed by a payment transfer of a transaction amount (i.e., monetary value) from one entity (e.g., issuing bank associated with the buyer) to another entity (e.g., acquiring bank associated with the seller), in exchange of any goods or services.

### Overview

Various embodiments of the present disclosure provide methods, systems, electronic devices, and computer program products for determining a representation of a node associated with a graph. In a specific embodiment, a server system can be embodied within a payment server associated with a payment gateway. The server system includes a processor and a memory.

In a non-limiting implementation, the server system is configured to access a multi-partite graph from a database associated with the server system. Herein, the server system is a payment server associated with a payment network. The multi-partite graph includes a plurality of node sets corresponding to a plurality of entity sets and one or more edges. Each node set includes a plurality of nodes representing a plurality of entities of an entity set. Each node is associated with a plurality of node-related features of an individual entity. An edge of the one or more edges indicates information related to a relationship between two distinct nodes connected by the edge. Further, the server system is configured to generate a multi-partite sub-graph from the multi-partite graph. The multi-partite sub-graph is generated from the multi-partite graph based, at least in part, on traversing the one or more edges from each node of the particular node set to one or more distinct nodes of the distinct node set.

Furthermore, the server system is configured to generate the multi-partite sub-graph by iteratively processing the multi-partite graph till each node of the multi-partite graph is traversed. The processing includes traversing the one or more edges of the multi-partite graph from a randomly selected starting node of the multi-partite graph for a predefined number of hops to determine one or more paths. Herein, the one or more paths indicate a k-hop relation between the central node and the each leaf node, and the predefined number of hops indicates a number of the one or more edges present between the central node and the each leaf node. Here, k indicates a natural number. The one or more paths indicate a distinct relation type between the central node and each leaf node. The predefined number of hops indicates a number of the one or more edges present between the central node and the each leaf node. The processing further includes extracting the central node and the each leaf node connected by the one or more paths, preserving a structure of the multi-partite graph. Herein, the randomly selected starting node is the central node during the traversing step. The processing further includes randomly re-selecting another central node from the multi-partite graph for the next iteration. Herein, the another central node is distinct from the extracted central node.

Additionally, the server system is configured to determine for the each node of the each node set of the multi-partite graph a first label category count and a second label category count for an individual node. Determination of the first label category count and the second label category count is based, at least in part, on the information associated with the one or more edges connected to the individual node. Herein, the information for each edge of the one or more edges indicates whether a corresponding edge is associated with a first label category or a second label category. Moreover, the server system is configured to label the individual node with the first label category. The server system is configured to label the individual node with the first label category upon determining that the first label category count is at least equal to a threshold percentage of a total edge count of the one or more edges. Also, the server system is configured to label the individual node with the second label category. The server system is configured to label the individual node with the second label category upon determining that the second label category count is at least equal to the threshold percentage of the total edge count of the one or more edges. Herein, the first label category is a fraudulent transaction, and the second label category is a non-fraudulent transaction.

Further, the server system is configured to access the multi-partite sub-graph from the database. The multi-partite sub-graph includes the central node connected with one or more leaf nodes through the one or more paths. The central node belonging to a particular node set represents a particular entity set. The one or more leaf nodes belonging to a distinct node set represent a distinct entity set. Each path is associated with a distinct relation type. Furthermore, the server system is configured to extract a central node feature set associated with the central node and a leaf node feature set associated with each leaf node of the one or more leaf nodes from the multi-partite sub-graph. Moreover, the server system is configured to determine, by a Machine Learning (ML) model associated with the server system, a first node representation for the central node based, at least in part, on the distinct relation type of each path, the central node feature set, and the leaf node feature set. Additionally, the server system is configured to determine a second node representation for the central node based, at least in part, on concatenating individual path feature vectors of each path. Also, the server system is configured to determine a final node representation for the central node based, at least in part, on the first node representation and the second node representation.

Further, the server system is configured to generate central node representation for the central node based, at least in part, on the central node feature set. Furthermore, the server system is configured to generate leaf node representation for the each leaf node of the one or more leaf nodes based, at least in part, on the leaf node feature set. Moreover, the server system is configured to aggregate leaf node representation for the distinct relation type of each path based, at least in part, on the distinct relation type. Additionally, the server system is configured to generate the first node representation based, at least in part, on the central node representation and the aggregated leaf node representation.

Further, the server system is configured to receive a prediction request for a down-stream task for an entity. Herein, the entity is represented by the central node in the multi-partite sub-graph. Furthermore, the server system is configured to generate by a down-stream task prediction model, a prediction associated with the central node based, at least in part, on the final node representation for the central node.

Additionally, the server system is configured to train the ML model to determine the first node representation based, at least in part, on a set of operations until a predefined output is obtained. In one embodiment, the set of operations can include: (i) initializing the ML model based, at least in part, on one or more ML model parameters. Herein, the one or ML model parameters includes a set of weights (ii) generating the first node representation based, at least in part, on the distinct relation type, the central node feature set, and the leaf node feature set (iii) computing loss function by comparing the first node representation with a true label (iv) optimizing the set of weights based, at least in part, on the loss function.

Various embodiments of the present disclosure offer multiple advantages and technical effects. For instance, the present disclosure aims to enhance the accuracy of predictions for a down-stream task by deriving additional features from tabular data. The proposed approach generates a multi-partite graph from the tabular data to capture the subtle relationship between various entities, which would not otherwise be possible using the tabular data. Such an approach can improve predictive performance, especially in tasks involving networked data or relational reasoning. Further, the proposed approach utilizes a supervised ML model to generate additional features. The ML model generates the additional features that are relevant to the down-stream task since it is trained using down-stream task-specific features. Furthermore, the proposed approach utilizes an unsupervised model for extracting the additional features from the multi-partite graph. The unsupervised model identifies hidden relationships between various entities present in the graph, leading to the identification of transferable features.

Considering an exemplary scenario of a payment ecosystem, a service provider is tasked with generating a risk score associated with a transaction. The risk score indicates a probability of the transaction being fraudulent. The risk score can be utilized by an issuer/acquirer to authorize or reject a transaction. The service provider relies on transaction records to generate the risk score. Since the transaction records are stored in a tabular format, the generation of the risk score by the service provider would be based on various transaction attributes associated with a particular transaction. The risk score generated by such an approach fails to capture the interconnection between other transactions, such as repeated patterns between the same cardholders, merchants, or Internet Protocol (IP) addresses, which may signal fraud.

Now, to solve this problem, an application of the approach provided by the various embodiments described herein is performed. To overcome this problem, the service provider generates a multi-partite graph based, at least in part, on the transaction data. The service provider represents various entities in the transaction records as nodes of the multi-partite graph and the interaction between the entities as edges between each node. Then, the service provider utilizes a supervised Machine Learning (ML) model and an unsupervised ML model to determine a representation of each node considering the features of the neighboring nodes. By doing so, the service provider is able to capture the subtle relationship between various entities present in the transaction data (i.e., merchants, IP addresses, and cardholders). Herein, the representation of each node indicates an updated feature set of the each node considering the features of the neighboring nodes. Further, the service provider can provide the representation of the each node to a risk prediction model to generate a risk score associated with the transaction. The risk score thus generated will be more accurate compared to the previous risk score since it is generated based on the additional context derived from the subtle relationships between the other transactions.

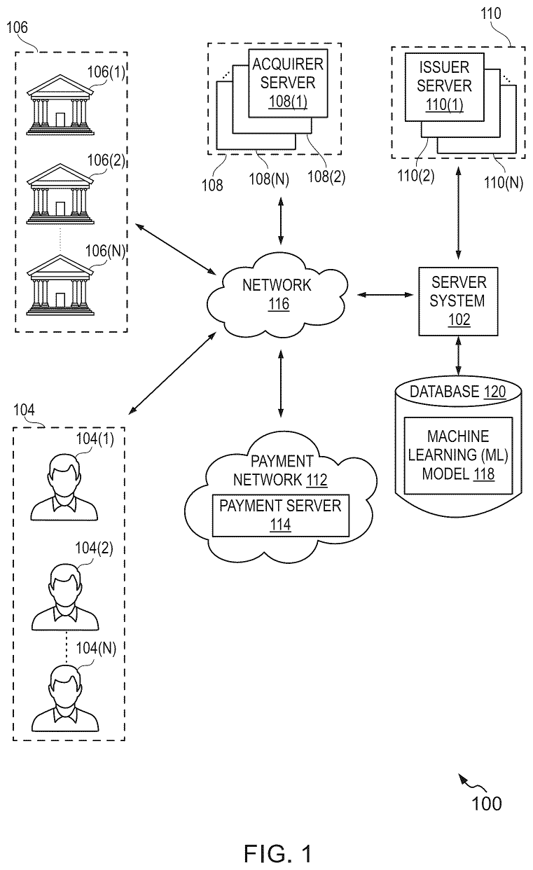

Various example embodiments of the present disclosure are described hereinafter with reference to FIG. 1 to FIG. 8.

FIG. 1 illustrates an exemplary representation of an environment 100 related to at least some embodiments of the present disclosure. Although the environment 100 is presented in one arrangement, other embodiments may include the parts of the environment 100 (or other parts) arranged otherwise depending on, for example, determining a representation of a node associated with a graph and the like.

The environment 100 generally includes a plurality of components such as a server system 102, a payment network 112 including a payment server 114, a database 120, a ML model 118, a plurality of entities such as a plurality of cardholders 104(1), 104(2), 104(N) (collectively, referred to as the ‘plurality of cardholders 104’ and ‘N’ is a Natural number), a plurality of merchants 106(1), 106(2), . . . , 106(N) (collectively, referred to as the ‘plurality of merchants 106’ and ‘N’ is a Natural number), a plurality of acquirers 108(1), 108(2), . . . , 108(N) (collectively, referred to as the ‘plurality of acquirers 108’ and ‘N’ is a Natural number), a plurality of issuers 110(1), 110(2), . . . , 110(N) (collectively, referred to as the ‘plurality of issuers 110’ and ‘N’ is a Natural number), each coupled to, and in communication with (and/or with access to) a network 116. Herein, the payment network 112 indicates companies that connect an issuing bank with an acquiring bank to facilitate payment. The payment server 114 is responsible for facilitating the various operations of the payment network 112.

It is noted that these entities may be classified or segregated based, at least in part, on their relationship in the payment network 112 or the network 116 with each other in the payment ecosystem. The network 116 may include, without limitation, a Light Fidelity (Li-Fi) network, a Local Area Network (LAN), a Wide Area Network (WAN), a Metropolitan Area Network (MAN), a satellite network, the Internet, a fiber optic network, a coaxial cable network, an Infrared (IR) network, a Radio Frequency (RF) network, a virtual network, and/or another suitable public and/or private network capable of supporting communication among two or more of the parts or users illustrated in FIG. 1, or any combination thereof.

Various entities in the environment 100 may connect to the network 116 in accordance with various wired and wireless communication protocols, such as Transmission Control Protocol/Internet Protocol (TCP/IP), User Datagram Protocol (UDP), 2nd Generation (2G), 3rd Generation (3G), 4th Generation (4G), 5th Generation (5G) communication protocols, Long Term Evolution (LTE) communication protocols, future communication protocols or any combination thereof. For example, the network 116 may include multiple different networks, such as a private network made accessible by the server system 102 and a public network (e.g., the Internet, etc.) through which the server system 102, the plurality of acquirers 108 (also referred as acquirer servers 108), the plurality of issuers 110 (also referred as issuer servers 110), and the payment server 114 may communicate.

In an embodiment, the plurality of cardholders 104 (or cardholders 104) uses one or more payment cards to make payment transactions at the plurality of merchants 106 (or merchants 106). A cardholder (e.g., the cardholder 104(1)) may be any individual, representative of a corporate entity, a non-profit organization, or any other person that is presenting payment account details during an electronic payment transaction with a merchant (e.g., the merchant 106(1)). The cardholder (e.g., the cardholder 104(1)) may have a payment account issued by the issuing bank (not shown in figures) associated with an issuer server (e.g., issuer server 110(1)) from the plurality of the issuer servers 110 (explained later). The cardholder may be provided a payment card with financial or other account information encoded onto the payment card such that the cardholder (i.e., the cardholder 104(1)) may use the payment card to initiate and complete a payment transaction using a bank account at the issuing bank.

In an example, the cardholders 104 may use their corresponding electronic devices (not shown) to access a mobile application or a website associated with the issuing bank or any third-party payment application. In various non-limiting examples, electronic devices may refer to any electronic devices such as, but not limited to, Personal Computers (PCs), tablet devices, Personal Digital Assistants (PDAs), voice-activated assistants, Virtual Reality (VR) devices, smartphones, and laptops.

In an embodiment, the merchants 106 may include retail shops, restaurants, supermarkets or establishments, government and/or private agencies, or any such places equipped with POS terminals, where an individual such as the cardholders 104 visits to perform the financial transaction in exchange for any goods and/or services or any financial transactions.

In one scenario, the cardholders 104 may use their corresponding payment accounts or payment cards to conduct payment transactions with the merchants 106. Moreover, it may be noted that each of the cardholders 104 may use their corresponding payment card from the payment cards differently or make the payment transaction using different means of payment. For instance, the cardholder 104(1) may enter payment account details on an electronic device (not shown) associated with the cardholder 104(1) to perform an online payment transaction. In another example, the cardholder 104(2) may utilize the payment card to perform an offline payment transaction. For example, the cardholder 104(3) may enter details of the payment card to transfer funds in the form of fiat currency on an e-commerce platform to buy goods. In another instance, each cardholder (e.g., the cardholder 104(1)) of the cardholders 104 may transact at any merchant (e.g., the merchant 106(1)) from the merchants 106.

In one embodiment, the cardholders 104 is associated with the plurality of issuer servers 110 (or issuer servers 110). In one embodiment, an issuer server such as issuer server 110(1) is associated with a financial institution normally called an “issuer bank”, “issuing bank,” or simply “issuer”, in which a cardholder (e.g., the cardholder 104(1)) may have the payment account, (which also issues a payment card, such as a credit card or a debit card), and provides microfinance banking services (e.g., payment transaction using credit/debit cards) for processing electronic payment transactions, to the cardholder (e.g., the cardholder 104(1)).

In an embodiment, the merchants 106 is associated with the plurality of acquirer servers 108. In an embodiment, each merchant (e.g., the merchant 106(1)) is associated with an acquirer server (e.g., the acquirer server 108(1)). In one embodiment, the acquirer server 108(1) is associated with a financial institution (e.g., a bank) that processes financial transactions for the merchant 106(1). This can be an institution that facilitates the processing of payment transactions for physical stores, merchants (e.g., the merchant 106(1)), or institutions that own platforms that make either online purchases or purchases made via software applications possible (e.g., shopping cart platform providers and in-app payment processing providers). The terms “acquirer”, “acquiring bank”, “acquiring bank,” or “acquirer server” will be used interchangeably herein.

As described earlier, data is vital for decision-making, as it offers insights that reduce uncertainty and help organizations understand trends and patterns. Even though the data is helpful on many fronts, the data stored in tabular format has several limitations. One major limitation is that it treats each row as an independent instance, making it difficult to capture relationships or dependencies between various entities present in the data. This leads to a lack of contextual information, as tabular data typically does not account for how different entities may influence each other. Another drawback is that the tabular format represents data in a flat, rigid structure, which cannot easily model dynamic or evolving connections over time. Additionally, tabular data often requires significant feature engineering to manually extract meaningful patterns, relationships, or interactions, which can be both time-consuming and prone to error. The structure of tabular data also limits its ability to handle complex, hierarchical, or multi-dimensional relationships that may be important for specific analyses. Also, many machine learning algorithms assume that the data points are independent, which can result in suboptimal performance for tasks that require understanding interactions between various entities. These limitations make it challenging to represent and analyze interconnected or evolving data effectively.

The above-described technical problem, among other problems, is addressed by one or more embodiments implemented by the server system 102 of the present disclosure. In one embodiment, the server system 102 is configured to perform one or more of the operations described herein.

In an embodiment, the server system 102 may be coupled to the database 120. In one embodiment, the database 120 may be incorporated in the server system 102 or maybe an individual entity connected to the server system 102, or maybe the database 120 stored in cloud storage. In various non-limiting examples, the database 120 may include one or more Hard Disk Drives (HDD), Solid-State Drives (SSD), an Advanced Technology Attachment (ATA) adapter, a Serial ATA (SATA) adapter, a Small Computer System Interface (SCSI) adapter, a redundant array of independent disks (RAID) controller, a Storage Area Network (SAN) adapter, a network adapter, and/or any component providing the server system 102 with access to the database 120. In one implementation, the database 120 may be viewed, accessed, amended, updated, and/or deleted by an administrator (not shown) associated with the server system 102 through a database management system (DBMS) or Relational DBMS (RDBMS) present within the database 120.

In an embodiment, the database 120 may store the ML model 118. As may be understood, the ML model 118 is an Artificial Intelligence (AI) or Machine Learning (ML) model that is responsible for determining the first node representation for the central node associated with the multi-partite sub-graph. The operation of the ML model 118 has been described later in the present disclosure. In one embodiment, the database 120 may be incorporated in the server system 102 or maybe an individual entity connected to the server system 102 or maybe a database stored in a cloud storage.

In a non-limiting implementation, the server system 102 can derive additional features from tabular data stored in the database 120. These additional features can be used to enhance the performance of the down-stream task. In various examples, the tabular data may include, but is not limited to, transaction data, social media data, health care data, and the like. In particular, the server system 102 accesses the multi-partite sub-graph from the database 120. The multi-partite sub-graph is derived from a multi-partite graph formed based, at least in part, on the tabular data. The formation of the multi-partite sub-graph from the multi-partite graph has been described further later in the present disclosure. The multi-partite sub-graph includes the central node. Herein, the central node refers to the node for which the representation has to be determined for enhancing the performance of the down-stream task. The central node is connected with one or more leaf nodes through one or more paths. Each path in the one or more paths is associated with a distinct relation type. Herein, the distinct relation type indicates how the central node is related to each leaf node of the one or more leaf nodes. In various examples, the distinct relation type may include, but is not limited to, one hop relation, two hop relation, and the like. Herein, hop refers to the number of edges present between the central node and the one or more leaf nodes.

The central node belongs to a particular node set representing a particular entity set. In various examples, the particular node set may include, but is not limited to, a merchant node set, an Internet Protocol (IP) node set, and a Permanent Account Number (PAN) node set, a social media account node set, a patient identifier (ID) node set, and the like. The one or more leaf nodes belong to a distinct node set representing a distinct entity set. In various examples, the distinct node set may include, but is not limited to, a merchant node set, a PAN node set, an IP node set, a patient ID node set, and the like.

In an exemplary implementation, the multi-partite sub-graph has three nodes such as the merchant node, the IP node, and the PAN node. The merchant node is connected to the IP node through an edge. Hence, the distinct relation between the merchant node and the IP node is the one hope relation since there exists only one edge between the merchant node and the IP node. The IP node is connected to the PAN node through a subsequent edge. The distinct relation between the PAN node and the IP node is a one-hop relation since only one edge is present between the PAN node and the IP node. Similarly, the distinct relation between the merchant node and the PAN node is a two-hop relation since there exist two edges between the merchant node and the PAN node.

If the merchant node is selected as the central node, then the IP node and the PAN node can be treated as leaf nodes. If the IP node is selected as the central node, then the PAN node and the merchant node can be treated as the leaf nodes. If the PAN node is selected as the central node, then the IP node and the merchant node can be treated as the leaf nodes. Even though the multi-partite sub-graph having three nodes is selected, the multi-partite sub-graph can include any number of nodes.

Upon accessing the multi-partite sub-graph, the server system 102 extracts a central node feature set associated with the central node and a leaf node feature set associated with each leaf node of the one or more leaf nodes from the multi-partite sub-graph. The central node feature set and the leaf node feature set can include multiple features. In various examples, the multiple features may include, but are not limited to, a transaction time, a merchant category, a device type, a transaction channel, browser information, an issuer location, an acquirer location, a transaction amount, frequency of transactions, a transaction type, a location correlation, statistical features derived from at least one of response scores, decline counts, Identity Protection Verification (IPV) scores, the transaction amount and the like. In various examples, the statistical features may include, but are not limited to, minimum (min), maximum (max), mean, and variance.

Herein, the transaction time indicates a time at which a transaction happened, and the merchant category indicates a type of merchant associated with the transaction. Further, the device type indicates a type of device used for performing the transaction, and the transaction channel indicates a channel through which the transaction occurred. In various examples, the transaction channel may include, but is not limited to, mobile, web, and the like. Herein, the browser information indicates information associated with a browser used for performing the transaction. In various examples, the browser information may include, but is not limited to, a version of the browser, a type of browser, one or more settings of the browser, and the like. Further, the issuer location indicates a geographical location of the issuer, and the acquirer location indicates a geographical location of the acquirer.

Here, the transaction amount indicates the amount of money involved in the transaction, and the frequency of transactions indicates the number of transactions occurring between two distinct nodes. Furthermore, the transaction type indicates whether the transaction is a cross-border transaction or not. Here, the location correlation indicates a geographical correlation between nodes involved in the transaction. Further, the decline counts indicate the number of times a transaction request has been rejected, and the IPV score indicates the authenticity score associated with a cardholder's identity in the context of fraud prevention. Herein, the term ‘minimum’ in the present context indicates the smallest value in a dataset. Here, the term ‘maximum’ in the present context indicates the largest value in the dataset. Further, the mean indicates an average value of the dataset, and the variance indicates a measure of the dispersion of values in the dataset.

In one embodiment, the multiple features are represented as numerical values in each of the central node feature set and the leaf node feature set. In a non-limiting example, assuming the merchant node is the central node and the PAN node and the IP node as the leaf nodes. The central node feature set associated with the merchant node can be represented as a first matrix having dimensions m×1 where m is a positive integer. The leaf node feature set associated with the IP node and the PAN node can be represented as a second matrix and a third matrix, respectively. The dimensions of the second matrix and the third matrix can be m×1, where m is a positive integer.

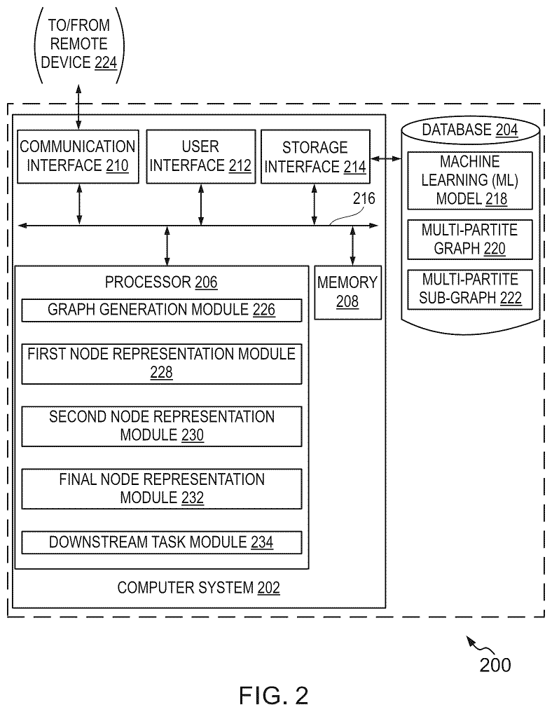

Further, the server system 102 determines a first node representation for the central node, based, at least in part, on the distinct relation type, the central node feature set, and the leaf node feature set. In particular, for determining the first node representation of the central node, the server system 102 utilizes the ML model 118. The ML model 118 uses a corresponding weight set for each of the distinct relation types, such as the one-hop relation and the two-hop relation, while determining the first node representation. The process of determining the first node representation is described further in detail with reference to FIG. 2.

Further, the server system 102 determines a second node representation for the central node based, at least in part, on concatenating individual path feature vectors of each path. The individual path feature vector indicates a feature vector obtained by concatenating the feature vector associated with the central node and a leaf node sharing the distinct relation type. If there exists more than one path associated with the central node, the central node feature set is selected only once during the concatenation. The feature vector associated with the central node can be derived from the feature set associated with the central node. The feature vector associated with the each leaf node can be derived from the leaf node feature set associated with the each leaf node. Returning to the previous example, the second node representation of the merchant node feature can be determined by concatenating the individual path feature vector of the different paths (hops) associated with the merchant node. The different paths may include a path between the merchant node and the IP node (one hop) and a path between the merchant node and the PAN node (second hop).

Furthermore, the server system 102 determines a final node representation for the central node based, at least in part, on the first node representation and the second node representation. In a non-limiting implementation, the server system 102 can concatenate the first node representation and the second node representation to determine the final node representation. For example, if the first node representation is [1,2,3] and the second node representation is [4,5,6], then the final node representation will be [1,2,3,4,5,6].

In other words, the server system 102 generates the multi-partite graph using the tabular data. Then, the server system 102 generates the multi-partite sub-graph from the multi-partite graph. The multi-partite sub-graph includes the central node, and the leaf nodes are related to each other through one or more paths. The server system 102 then determines the final node representation for the central node by capturing features from the leaf nodes present in the neighborhood of the central node. By doing so, the server system 102 captures the subtle features present between the central node and the one or more leaf nodes, which otherwise wouldn't be possible using the tabular data. These subtle features can be utilized to enhance the performance of the down-stream task. It is noted that the various aspects described with reference to FIG. 1 have been described further in detail with FIG. 2 later on.

The number and arrangement of systems, devices, and/or networks shown in FIG. 1 are provided as an example. There may be additional systems, devices, and/or networks; fewer systems, devices, and/or networks; different systems, devices, and/or networks; and/or differently arranged systems, devices, and/or networks than those shown in FIG. 1. Furthermore, two or more systems or devices shown in FIG. 1 may be implemented within a single system or device, or a single system or device is shown in FIG. 1 may be implemented as multiple, distributed systems or devices. In addition, the server system 102 should be understood to be embodied in at least one computing device in communication with the network 116, which may be specifically configured, via executable instructions, to perform steps as described herein, and/or embodied in at least one non-transitory computer-readable media.

FIG. 2 illustrates a simplified block diagram of a server system 200, in accordance with an embodiment of the present disclosure. The server system 200 is identical to the server system 102, described with reference to FIG. 1. The server system 200 can be a payment server 114 associated with the payment network 112. In some embodiments, the server system 200 is embodied as a cloud-based and/or software as a service (SaaS)-based architecture.

The server system 200 includes a computer system 202 and a database 204. The computer system 202 includes at least one processor 206 (herein, referred to interchangeably as ‘processor 206’) for executing instructions, a memory 208, a communication interface 210, a user interface 212, and a storage interface 214. One or more components of the computer system 202 communicate with each other via a bus 216. The components of the server system 200 provided herein may not be exhaustive, and the server system 200 may include more or fewer components than those depicted in FIG. 2. Further, two or more components depicted in FIG. 2 may be embodied in one single component, and/or one component may be configured using multiple sub-components to achieve the desired functionalities.

In some embodiments, the database 204 is integrated into the computer system 202. In one non-limiting example, the database 204 is configured to store the ML model 218, a multi-partite graph 220, and a multi-partite sub-graph 222. Herein, the multi-partite graph 220 indicates a graph where nodes are divided into multiple disjoint sets, and edges only connect nodes from different sets, not within the same set. Here, the multi-partite sub-graph 222 indicates a graph derived from the multi-partite graph 220. The ML model 218 is identical to the ML model 118 described with reference to FIG. 1. In a non-limiting example, the multi-partite graph 220 can include a plurality of node sets corresponding to a plurality of entity sets. In various examples, the plurality of entity sets may include, but are not limited to, merchant sets, IP address sets, PAN sets, and the like. The multi-partite sub-graph 222 can include the central node and the one or more leaf nodes. In various examples, the central node and the one or more leaf nodes may include, but are not limited to, the merchant node, the IP node, the PAN node, and the like.

In addition, the database 204 provides a storage location for data and/or metadata obtained from various operations performed by the server system 200. In one embodiment, the database 204 is substantially similar to the database 120 of FIG. 1. Thus, it should be understood that all the details, data, or information as described in the description of FIG. 1 to be stored in the database 120 are applicable to the database 204 as well.

Further, the computer system 202 may include one or more hard disk drives as the database 204. The user interface 212 is an interface, such as a Human Machine Interface (HMI) or a software application, that allows users, such as an administrator, to interact with and control the server system 200 or one or more parameters associated with the server system 200. It may be noted that the user interface 212 may be composed of several components that vary based on the complexity and purpose of the application. Examples of components of the user interface 212 may include visual elements, controls, navigation, feedback and alerts, user input and interaction, responsive design, user assistance and help, accessibility features, and the like. More specifically, these components may correspond to icons, layout, color schemes, buttons, sliders, dropdown menus, tabs, links, error/success messages, mouse and touch interactions, keyboard shortcuts, tooltips, screen readers, and the like.

The storage interface 214 is any component capable of providing the processor 206 access to the database 204. The storage interface 214 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 206 with access to the database 204.

The processor 206 includes suitable logic, circuitry, and/or interfaces to execute operations for determining the final node representation for the central node and generating a prediction associated with the central node based, at least in part, on the final node representation. Examples of the processor 206 include, but are not limited to, an Application-Specific Integrated Circuit (ASIC) processor, a Reduced Instruction Set Computing (RISC) processor, a Graphical Processing Unit (GPU), a Complex Instruction Set Computing (CISC) processor, a Field-Programmable Gate Array (FPGA), and the like.

The memory 208 includes suitable logic, circuitry, and/or interfaces to store a set of computer-readable instructions for performing the various operations described herein. Examples of the memory 208 include a Random-Access Memory (RAM), a Read-Only Memory (ROM), a removable storage drive, a Hard Disk Drive (HDD), and the like. It will be apparent to a person skilled in the art that the scope of the disclosure is not limited to realizing the memory 208 in the server system 200, as described herein. In another embodiment, the memory 208 may be realized in the form of a database server or a cloud storage working in conjunction with the server system 200 without departing from the scope of the present disclosure.

The processor 206 is operatively coupled to the communication interface 210, such that the processor 206 is capable of communicating with a remote device 224, such as the issuer servers 110, the acquirer servers 108, the payment network 112, or communicating with any entity connected to the network 116 (as shown in FIG. 1).

It is noted that the server system 200, as illustrated and hereinafter described, is merely illustrative of an apparatus that could benefit from embodiments of the present disclosure and, therefore, should not be taken to limit the scope of the present disclosure. It is noted that the server system 200 may include fewer or more components than those depicted in FIG. 2.

In one implementation, the processor 206 includes a graph generation module 226, a first node representation module 228, a second node representation module 230, a final node representation module 232, and a down-stream task module 234. It should be noted that components described herein, such as the graph generation module 226, the first node representation module 228, the second node representation module 230, the final node representation module 232, and the down-stream task module 234, can be configured in a variety of ways, including electronic circuitries, digital arithmetic, and logic blocks, and memory systems in combination with software, firmware, and embedded technologies. Moreover, it may be noted that the graph generation module 226, the first node representation module 228, the second node representation module 230, the final node representation module 232, and the down-stream task module 234 may be communicably coupled with each other to exchange information with each other for performing the one or more operations facilitated by the server system 200.

In an embodiment, the graph generation module 226 includes suitable logic and/or interfaces for generating the multi-partite graph 220. In particular, for generating the multi-partite graph 220, the graph generation module 226 accesses the tabular data (not shown) from the database 204. In various examples, the tabular data may refer to transaction data, health care data, social media data, and the like. The graph generation module 226 performs a series of operations to generate the multi-partite graph 220. These series of operations may be initiated by accessing the tabular data by the graph generation module 226. Then, the graph generation module 226 identifies a plurality of entity sets present in the tabular data. In various examples, the plurality of entity sets may include, but are not limited to, a set of merchants, a set of IP addresses, a set of PANs, a set of patients, a set of doctors, a set of followers, a set of friends, and the like. The graph generation module 226 also identifies relationships between distinct entities. In various examples, the relationships may include, but are not limited to, friend, patient, doctor, follower, transactional relationship, and the like.

Further, the graph generation module 226 generates the multi-partite graph 220, including a plurality of node sets and one or more edges. Herein, the multi-partite graph 220 can be generated based, at least in part, on the plurality of entity sets and the relationship identified by the graph generation module 226. In the multi-partite graph 220, the plurality of node sets represents the plurality of entity sets. Each node set includes a plurality of nodes representing a plurality of entities of an entity set. Each node in the each node set is associated with a plurality of node-related features of an individual entity. Also, each edge of the one or more edges indicates information related to the relationship between two distinct nodes connected by the edge.

Each edge of the one or more edges may be associated with a corresponding weight. The corresponding weight may be proportional to a number of interactions between the respective nodes connected by that edge. In various examples, the plurality of node-related features may include, but are not limited to, transaction time, merchant category, device type, transaction channel, browser information, issuer and acquirer location, statistical features derived from response scores, decline counts, IPV scores, transaction amounts that recorded during a predefined time period.

The graph generation module 226 further labels the each node of the each node set as a first label category or a second label category. In a specific implementation where the each node is related to a transaction, the first label category indicates a fraudulent transaction, and the second label category indicates a non-fraudulent transaction. Herein, labeling of each node is necessary since the ML model 218 requires labeled nodes for determining the first node representation as it is a supervised ML model. In order to label the each node, the graph generation module 226 determines a first label category count and the second label category count for an individual node.

Then, a first label category count and the second label category count are determined based, at least in part, on the information associated with the one or more edges connected to the individual node. Herein, the information for each edge of the one or more edges indicates whether a corresponding edge is associated with the first label category or the second label category. In response to determining that the first label category count is at least equal to a threshold percentage of a total edge count of the one or more edges, labeling the individual node with the first label category. Herein, the threshold percentage indicates a predefined percentage set by the administrator. Alternatively, in response to determining that the second label category count is at least equal to the threshold percentage of the total edge count of the one or more edges, labeling the individual node with the second label category.

For example, the individual node is connected with ten edges. Here, among ten edges, two edges are associated with the first label category, and eight edges are associated with the second label category. Hence, the first label category count and the second label category count for the individual node are two and eight, respectively. Herein, the first label category count and the second label category count are twenty percent and eighty percent, respectively, with respect to the total edge count. Assuming the threshold percentage as sixty percent. Then, the percentage associated with the second label category is at least equal to the threshold percentage. Hence, the individual node is labeled as the first label category.

After labeling the each node, the graph generation module 226 utilizes the multi-partite graph 220 to generate a multi-partite sub-graph 222. For generating the multi-partite sub-graph 222 from the multi-partite graph 220, a random walk is performed. Herein, the random walk indicates a process that describes a path formed by a sequence of random steps on some space, such as the multi-partite graph 220. In particular, for generating the multi-partite sub-graph 222, the graph generation module 226 traverses the one or more edges from each node of the particular node set to one or more distinct nodes of the distinct node set. Traversing the one or more edges from the each node of the particular node set can be an iterative process involving multiple steps. Initially, the central node from the multi-partite graph 220 is randomly selected. Then, the one or more edges connected to the central node are traversed for a predefined number of hops to determine the one or more paths. As used herein, the one or more paths indicate a k-hop relation between the central node and the each leaf node. Here, k may be a non-zero natural number. Herein, the predefined number of hops indicates a number of the one or more edges present between the central node and the each leaf node. The one or more paths indicate the distinct relation type between the central node and the each leaf node. Then, the graph generation module 226 extracts the central node the each leaf node connected by the one or more paths, preserving a structure of the multi-partite graph 220. Further, the graph generation module 226 randomly reselects another central node from the multi-partite graph 220 for the next iteration. The another central node will be distinct from the previously selected central node.

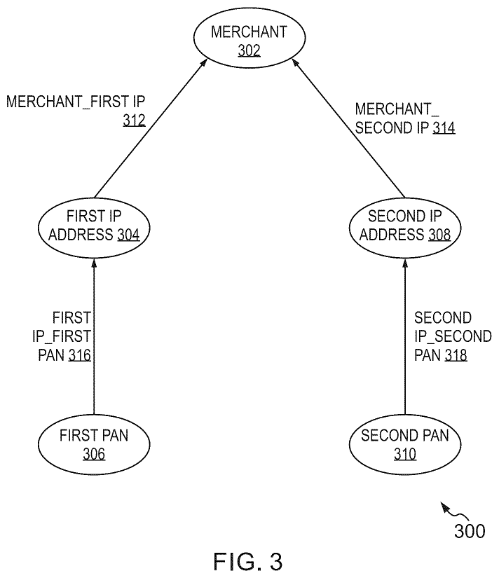

The multi-partite sub-graph 222 thus obtained includes the central node connected with one or more leaf nodes through the one or more paths. The central node belongs to the particular node set representing the particular entity set. The one or more leaf nodes belong to the distinct node set representing the distinct entity set. Each path of the one or more paths is associated with the distinct relation type. The central node, the one or more leaf nodes, and the distinct relation type are explained in detail with reference to the FIG. 1. Hence, for the sake of brevity, they are not explained here again. A schematic exemplary representation of a multi-partite sub-graph 222 associated with a transaction has been described later in the present disclosure with reference to FIG. 3.

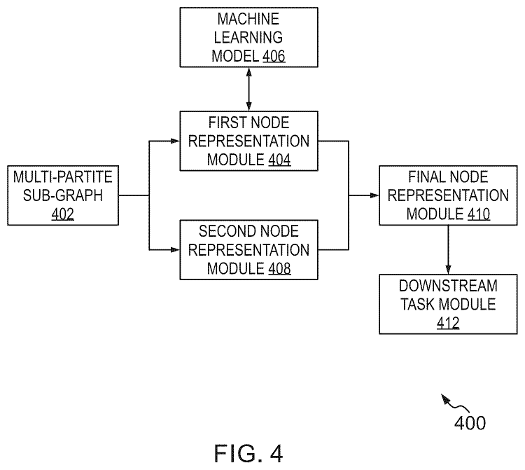

In an embodiment, the first node representation module 228 includes suitable logic and/or interfaces for determining the first node representation for the central node based, at least in part, on the distinct relation type of each path, the central node feature set, and the leaf node feature set. In particular, for determining the first node representation for the central node, the first node representation module 228 utilizes the ML model 218. The training process of the ML model 218 is explained further in detail later in the present disclosure with reference to FIG. 4. To determine the first node representation of the central node, the first node representation module 228 performs a series of operations. This series of operations may be initiated by generating a central node representation for the central node based, at least in part, on the central node feature set. In an example, the central node representation can be generated based, at least in part, on a convolution of the central node feature set. Then, a leaf node representation for the each leaf node of the one or more leaf nodes is generated based, at least in part, on the leaf node feature set. In an example, the leaf node representation is generated based, at least in part, on a convolution of the leaf node feature set. Further, the leaf node representation for the distinct relation type of each path is aggregated based, at least in part, on the distinct relation type. Then, the ML model 218 is utilized to generate the first node representation based, at least in part, on the central node representation and the aggregated leaf node representation.

In one scenario, the central node has the one hop relation with a first leaf node and a second leaf node and the two hop relation with a third leaf node. The first leaf node, the second leaf node, and the third leaf node are associated with respective leaf node representations. To aggregate the leaf node representation for the distinct relation type of each path, a series of steps are performed. These series of steps may be initiated by multiplying the leaf node representation of the first leaf node by the corresponding weight set associated with the first hop relation to generate a first transformed representation. The first transformed representation is then normalized using a normalization factor associated with the first leaf node. Herein, the normalization factor indicates a value used to adjust the influence of the each leaf node on the central node while determining the first node representation. Similarly, a second transformed representation and a third transformed representation are generated using the leaf node representation of the second leaf node and the third leaf node, respectively. After normalization, the first transformed representation, the second transformed representation, and the third transformed representation are aggregated to generate a transformed leaf node representation. The transformed leaf node representation is again added to the central node representation, and the resultant representation is then provided to an activation function to generate the first node representation. In various examples, the activation function may include, but is not limited to, a sigma activation function, Rectified Linear Unit (ReLU), and the like. The arithmetic equation used by the ML model 218 for determining the first node representation has been described later in the present disclosure with reference to FIG. 4.

In an embodiment, the second node representation module 230 includes suitable logic and/or interfaces for determining the second node representation for the central node based, at least in part, on concatenating individual path feature vectors of each path. The individual path feature vector indicates the feature vector obtained by concatenating the feature vector associated with the central node and a leaf node sharing the distinct relation type. If there exists more than one path associated with the central node, then the central node feature set is selected only once during the concatenation. The feature vector associated with the central node can be derived from the feature set associated with the central node. The feature vector associated with the each leaf node can be derived from the leaf node feature set associated with the each leaf node. For example, a merchant node has a one hop relation with an IP node and a two hop relation with a PAN node. Then, the second node representation of the merchant node can be determined by concatenating the individual path feature vector of the different paths (hops) associated with the merchant node. The different paths may include a path between the merchant node and the IP node (one hop) and a path between the merchant node and the PAN node (two hop relation).

In an embodiment, the final node representation module 232 includes suitable logic and/or interfaces for determining the final node representation for the central node based, at least in part, on the first node representation and the second node representation. In an example, the final node representation module 232 concatenates the first node representation and the second node representation to determine the final node representation. In an example, if the first node representation is [4,5,6] and the second node representation is [7,8,9] then the final node representation will be [4,5,6,7,8,9].

In an embodiment, the down-stream task module 234 includes suitable logic and/or interfaces for generating a prediction associated with the central node based, at least in part, on the final node representation for the central node. In particular, for generating a prediction associated with the central node, the down-stream task module 234 receives a prediction request for the down-stream task for an entity. The central node in the multi-partite sub-graph 222 represents the entity. In various examples, the entity may include, a merchant, PAN, IP address, patient, a doctor, social media user accounts, and the like. In various examples, the prediction request may include but is not limited to, a request for predicting a risk score associated with a transaction, a request for predicting a treatment compliance score, a request for predicting a social media engagement score, and the like.

In response to receiving the prediction request for the down-stream task, the down-stream task module 234 transmits the final node representation of the central node to a down-stream task prediction model. The down-stream task prediction module then generates a prediction associated with the central node based, at least in part, on the final node representation for the central node.

In a non-limiting example, the multi-partite graph 220 generated based, at least in part, on a healthcare database can be utilized for detecting cancer in patients. The multi-partite graph 220 includes a plurality of node sets, such as a patient node set, a doctor node set, and a healthcare provider node set. The patient node set includes a plurality of nodes representing a corresponding patent. The doctor node set includes a plurality of doctor nodes representing a corresponding doctor. The healthcare provider node set includes a plurality of healthcare providers representing a corresponding healthcare provider. The edge between two distinct nodes indicates how the two distinct nodes are related. For example, an edge between a patient node present in the patient node set and a doctor node present in the doctor node set represents an interaction between the patient node and the doctor node. In various examples, the interaction between the patient node and the doctor node may include, but is not limited to, appointments, consultations, and the like.

In another example, the edge between the doctor node and a healthcare provider node indicates an interaction between the doctor node and the healthcare provider node. In various examples, the interaction between the doctor node and the healthcare provider node may include but is not limited to, part-time consultation, full-time consultation, and the like. Each node in the patient node set is associated with a set of patient features. In various examples, the set of patient features may include, but is not limited to, age, symptoms, medical history, and the like. Each node in the doctor node set is associated with a set of doctor features. In various examples, the set of doctor features may include, but is not limited to, specialization, experience, and the like. Each node in the healthcare provider node set is associated with a set of healthcare provider features. In various examples, the healthcare provider features may include, but are not limited to, a location of the healthcare provider, an availability of a cancer screening facility, treatments offered, and the like.

Further, the server system 200 can generate the multi-partite sub-graph 222 from the multi-partite graph 220 by performing the random walk focusing on patients having predefined symptoms. In various examples, the predefined symptoms may include, but are not limited to, weight loss, fatigue, lumps, and the like. The multi-partite sub-graph 222 thus generated includes a subset of the patient node set, the doctor node set, and the health care provider node set. Furthermore, the server system 200 can determine the first node representation and the second node representation for a particular patient node associated with a patient (e.g., a patient X). For that, the server system 200 utilizes the feature set associated with at least one doctor node and at least one health care provider node connected to the particular patient node. Further, the server system 200 determines the final node representation of the particular patient node based, at least in part, on the first node representation and the second node representation.

In an example, the final node representation can include information related to the patient X. In various examples, the information may include, but is not limited to, the age, the symptoms, specialization of the doctor consulted by the patient X, treatments offered by the healthcare provider visited by the patient X, and the like. Furthermore, the server system 200 can provide the final node representation to a prediction model to generate a prediction. Herein, the prediction can indicate whether the patient X is affected by cancer or not. For example, suppose the final node representation indicates the presence of lumps, and consultation of an oncologist by the patient X. In that case, the prediction model may conclude that patient X is affected by cancer.

To summarize, the server system 200 generates the final node representation for the central node by capturing subtle patterns and interactions that exist between the central node and each leaf node. The server system 200 can utilize the final node representation to improve the accuracy of predictions generated by a down-stream task prediction model.

FIG. 3 illustrates a schematic representation of a multi-partite sub-graph 300, in accordance with an embodiment of the present disclosure. As described earlier, the graph generation module 226 of the server system 200 is configured to generate multi-partite sub-graph 300 based, at least in part, on traversing the one or more edges from each node of the particular node set to the one or more distinct nodes of the distinct node set.

As depicted in FIG. 3, the multi-partite sub-graph 300 represents transactions between different entities. In other words, a transaction between a merchant (represented using merchant node 302) and two distinct cardholders (represented with first PAN node 306 and second PAN node 310) through respective IP addresses of two distinct devices (depicted using first IP address node 304 and second IP address node 308) initiating the transaction. As depicted, the multi-partite sub-graph 300 includes the plurality of node sets (e.g., merchant node 302, PAN nodes (see, 306, 310), and IP address nodes (see, 304, 308) associated with a plurality of entity sets (e.g., merchant set, cardholder set, and IP address set). Further, the nodes are connected via a plurality of edges (see, 312, 314, 316, and 318). It is noted that the plurality of edges (see, 312, 314, 316, and 318) indicates a relationship between the merchant node 302 with each of the first PAN node 306, and the second PAN node 310 via respective IP address nodes (see, 304, 308). In one instance, this relationship can be defined as a transaction performed between the cardholders 104 and the merchant 106(1) through respective cardholder devices having respective IP addresses.

Although the multi-partite sub-graph 300 describes transactions between different entities using five nodes from distinct node sets, it is understood that in a complex payment ecosystem, each node set may contain any number of nodes. Additionally, there may be any number of entity sets in such a system. Further, various data points from the 3D secure 2.0 (3DS2) data may be utilized to introduce different entity types to the multi-partite sub-graph 300. For instance, cardholder email, cardholder shipping address, Merchant Category Code (MCC), cardholder biometrics, and so on may be used to describe distinct entity sets that include various nodes corresponding to each entity type. For example, the multi-partite sub-graph 300 may be generated for multiple transactions between four entity sets including multiple nodes from each entity type as well.

For instance, the multi-partite sub-graph 300 may include the plurality of node sets represented by NS₁, NS₂, . . . , NSᵢ, NS₍ᵢ₊₁₎, . . . , NSₚ, where NSᵢ depicts an i^{th} node set, and p is a natural number. Here, the plurality of node sets is associated with a plurality of entity sets represented by ES₁, ES₂, . . . , ESᵢ, ES₍ᵢ₊₁₎, . . . , ESₚ, where ESᵢ is an i^{th} entity set, and p is a natural number. It is noted that each entity set is mapped to its corresponding node set. Further, each node set, such as NSᵢ, includes the plurality of nodes of the same entity types represented by N₁-ESᵢ, N₂-ESᵢ . . . , Nₚ-ESᵢ for an i^{th} entity set, where Nᵢ is the i^{th} node. In other words, each node set has different nodes of the same entity type. To that end, each node of a particular node set will correspond to a particular entity from the plurality of entities. This is represented by E₁-ESᵢ, E₂-ESᵢ, Eₚ-ESᵢ for an entity set, ESᵢ. For example, if the entity type is cardholder, then a cardholder node set will include a plurality of different cardholder nodes. Further, each of the nodes within the multi-partite sub-graph 300 may be connected by the one or more edges represented by e₁, e₂, . . . , eₘ, where eₘ is the m^{th} edge where m is a natural number. In some scenarios, the multi-partite sub-graph 300 may be generated for a particular time period T.

FIG. 4 illustrates a schematic representation of an architecture for determining a representation of a node associated with a graph, in accordance with an embodiment of the present disclosure. As described earlier, a first node representation module 404 extracts the central node feature set and the leaf node feature set from a multi-partite sub-graph 402. The first node representation module 404 and the multi-partite sub-graph 402 are identical to the first node representation module 228 and the multi-partite sub-graph 222 described with reference to FIG. 2. Then, the first node representation module 404 determines the first node representation for the central node based, at least in part, on the distinct relation type of each path, the central node feature set, and the leaf node feature set. To determine the first node representation, the first node representation module 404 utilizes an ML model 406. The ML model 406 is identical to the ML model 218 described with reference to FIG. 2. In a non-limiting implementation, the ML model 406 can be a Relational Graph Convolutional Network (R-GCN). In various examples, the ML model 406 may include, but is not limited to, Graph Convolutional Networks (GCN), Graph Attention Networks (GAT), Heterogeneous Graph Neural Networks (Hetero-GNN), Graph Sample and Aggregate (GraphSAGE), Simplified Graph Convolution (SGC), Graph Isomorphism Network (GIN), Relational Graph Attention Network (RGAT), Message Passing Neural Networks (MPNN), Dynamic Graph Neural Networks (DGNN), and Edge-Conditioned Convolution (ECC).

The server system 200 trains the ML model 406 to determine the first node representation based, at least in part, on a set of operations until a predefined output is obtained. Herein, the predefined output refers to an output expected by the administrator who takes part in the training. For training the ML model 406, the server system 200 initializes the ML model 406 based, at least in part, on one or more ML model parameters. The one or ML model parameters can include a set of weights. In an example, the ML model 406 can be randomly initialized using various initialization methods. In various examples, the various initialization methods include, but are not limited to, glorot (xavier), the initialization, uniform initialization, normal initialization, lecun initialization, orthogonal initialization, and the like.

Upon initialization, the ML model 406 generates the first node representation based, at least in part, on the distinct relation type, the central node feature set, and the leaf node feature set. The first node representation is compared with a true label to compute a loss function. Herein, the true label refers to an output that is expected for a particular epoch, and the loss function is the difference between the first node representation and the true label. Further, the server system 200 calculates gradients of the loss function for each weight in the set of weights. Then, each weight in the set of weights is optimized based, at least in part, on the gradients.

In a non-limiting example, the first node representation

$$( {h}_{i}^{( l + 1 )} )$$

can be computed using the following exemplary equation:

$${h}_{i}^{( l + 1 )} = σ ( {\sum }_{r ∈ R} {\sum }_{j ∈ {N}_{i}^{j}} \frac{1}{{c}_{i , r}} {W}_{r}^{( l )} {h}_{j}^{( l )} + {W}_{0}^{( l )} {h}_{i}^{( l )} ) \qquad Eqn . ( 1 )$$

Herein, i represents the central node and l represents the layer or hops. Σ_{r∈R} represents sum over all the distinct relation type r in a relation set R. In the RGCN, the edges between two distinct nodes can represent different types of relations. Each distinct relation type has a unique transformation matrix

$${W}_{r}^{( l )} .$$

The unique transformation matrix

$${W}_{r}^{( l )}$$

transforms the feature vector

$${h}_{j}^{( l )}$$

associated with the each leaf node j. Σ_{j∈N}_{ᵢ} represents the sum of each leaf node j of the central node i under the distinct relation type

$$r \cdot \frac{1}{{c}_{i , r}}$$

is a normalization factor that adjusts how much influence the each leaf node j has on the central node i.

$${W}_{0}^{( l )} {h}_{i}^{( l )}$$

allows the central node to incorporate its own features into the aggregated feature vectors of the leaf nodes. And σ represents the activation function.

Further, a second node representation module 408 determines the second node representation for the central node based, at least in part, on concatenating individual path feature vectors of each path. Then, a final node representation module 410 determines the final node representation for the central node based, at least in part, on the first node representation and the second node representation. The down-stream task module 412 further utilizes the final node representation to enhance the performance of the down-stream task. The second node representation module 408 and the final node representation module 410 are identical to the second node representation module 230 and the final node representation module 232, respectively, described with reference to the FIG. 2. The down-stream task module 412 is identical to the down-stream task module 234 described with reference to the FIG. 2. The second node representation module 408, the final node representation module 410, and the down-stream task module 412 are explained with reference to the FIG. 2. Hence, for the sake of brevity, these are not explained here again.

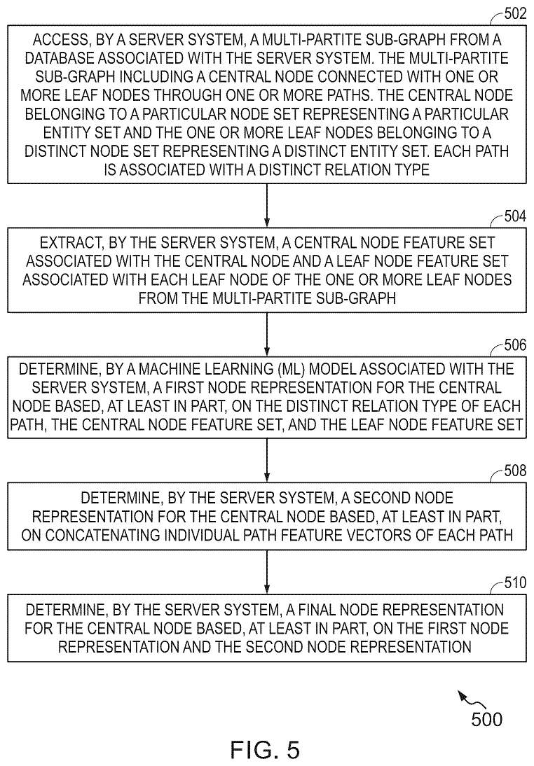

FIG. 5 illustrates a process flow diagram depicting a method 500 for determining a representation of a node associated with a graph, in accordance with an embodiment of the present disclosure. The method 500 depicted in the flow diagram may be executed by, for example, the server system 200. The sequence of operations of the method 500 may not be necessarily executed in the same order as they are presented. Further, one or more operations may be grouped and performed in the form of a single step, or one operation may have several sub-steps that may be performed in parallel or in a sequential manner. Operations of the method 500, and combinations of operations in the method 500 may be implemented by, for example, hardware, firmware, a processor, circuitry, and/or a different device associated with the execution of software that includes one or more computer program instructions. The plurality of operations is depicted in the process flow of the method 500. The process flow starts at operation 502.

At operation 502, the method 500 includes accessing, by a server system, such as the server system 200, a multi-partite sub-graph 222 from a database 204 associated with the server system 200. Herein, the multi-partite sub-graph 222 includes a central node connected with one or more leaf nodes through one or more paths. Further, the central node belongs to a particular node set representing a particular entity set. Furthermore, the one or more leaf nodes belong to a distinct node set representing a distinct entity set. Each path is associated with a distinct relation type.

At operation 504, the method 500 includes extracting, by the server system 200, a central node feature and a leaf node feature set. Here, the central node feature set is associated with the central node. Herein, the leaf node feature set is associated with each leaf node of the one or more leaf nodes from the multi-partite sub-graph 222.

At operation 506, the method 500 includes determining, by a Machine Learning (ML) model, such as ML model 218 associated with the server system 200, a first node representation for the central node. Herein, the first node representation is determined based, at least in part, on the distinct relation type of each path, the central node feature set, and the leaf node feature set.

At operation 508, the method 500 includes determining, by the server system 200, a second node representation for the central node based, at least in part, on concatenating individual path feature vectors of each path.

At operation 510, the method 500 includes determining, by the server system 200, a final node representation for the central node based, at least in part, on the first node representation and the second node representation.

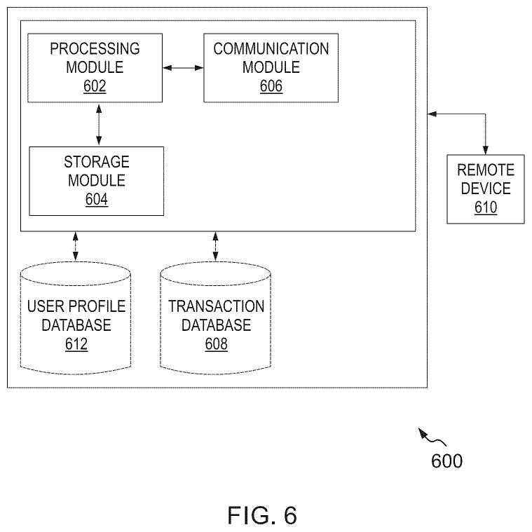

FIG. 6 illustrates a simplified block diagram of the acquirer server 600, in accordance with an embodiment of the present disclosure. The acquirer server 600 is an example of the acquirer server 108(1) of FIG. 1. The acquirer server 600 is associated with an acquirer bank/acquirer (not shown), in which a merchant 106(1) may have an account, which provides a payment card. The acquirer server 600 includes a processing module 602 operatively coupled to a storage module 604 and a communication module 606. The components of the acquirer server 600 provided herein may not be exhaustive, and the acquirer server 600 may include more or fewer components than those depicted in FIG. 6. Further, two or more components may be embodied in one single component, and/or one component may be configured using multiple sub-components to achieve the desired functionalities. Some components of the acquirer server 600 may be configured using hardware elements, software elements, firmware elements, and/or a combination thereof.

The storage module 604 is configured to store machine-executable instructions to be accessed by the processing module 602. Additionally, the storage module 604 stores information related to the contact information of the merchant 106(1), bank account number, availability of funds in the account, payment card details, transaction details, and/or the like. Further, the storage module 604 is configured to store payment transactions.

In one embodiment, the acquirer server 600 is configured to store profile data (e.g., an account balance, a credit line, details of the plurality of merchants 106, account identification information, and a payment card number) in a transaction database 608. The details of the plurality of merchants 106 may include, but are not limited to, name, age, gender, physical attributes, location, registered contact number, family information, alternate contact number, registered e-mail address, etc.

The processing module 602 is configured to communicate with one or more remote devices, such as a remote device 610, using the communication module 606 over a network such as the network 116 of FIG. 1. The examples of the remote device 610 include the server system 200, the payment server 114, the issuer server 110(1), or other computing systems of the acquirer server 600, and the like. The communication module 606 is capable of facilitating such operative communication with the remote devices and cloud servers using Application Program Interface (API) calls. The communication module 606 is configured to receive a payment transaction request performed by the plurality of cardholders 104 via the network 116. The processing module 602 receives payment card information, a payment transaction amount, cardholder information, and merchant information from the remote device 610 (i.e., the payment server 114). The acquirer server 600 includes a user profile database 612 and the transaction database 608 for storing transaction data. The user profile database 612 may include information of merchants 106. The transaction data may include but is not limited to, transaction attributes, such as transaction amount, source of funds such as bank or credit cards, transaction channel used for loading funds such as POS terminal or ATM machine, transaction velocity features, such as count and transaction amount sent in the past x days to a particular user, transaction location information, external data sources, and other internal data to evaluate each transaction.

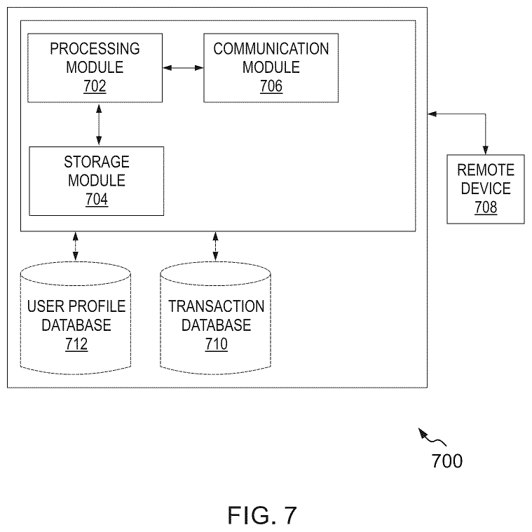

FIG. 7 illustrates a simplified block diagram of an issuer server 700, in accordance with an embodiment of the present disclosure. The issuer server 700 is an example of the issuer server 110(1) of FIG. 1. The issuer server 700 is associated with an issuer bank/issuer, in which an account holder (e.g., the plurality of cardholders 104(1)-104(N)) may have an account, which provides a payment card. The issuer server 700 includes a processing module 702 operatively coupled to a storage module 704 and a communication module 706. The components of the issuer server 700 provided herein may not be exhaustive, and the issuer server 700 may include more or fewer components than those depicted in FIG. 7. Further, two or more components may be embodied in one single component and/or one component may be configured using multiple sub-components to achieve the desired functionalities. Some components of the issuer server 700 may be configured using hardware elements, software elements, firmware elements, and/or a combination thereof.

The storage module 704 is configured to store machine-executable instructions to be accessed by the processing module 702. Additionally, the storage module 704 stores information related to the contact information of the cardholders (e.g., the plurality of cardholders 104(1)-104(N)), a bank account number, availability of funds in the account, payment card details, transaction details, payment account details, and/or the like. Further, the storage module 704 is configured to store payment transactions.

In one embodiment, the issuer server 700 is configured to store profile data (e.g., an account balance, a credit line, details of the cardholders 104, account identification information, payment card number, etc.) in a database 204. The details of the cardholders 104 may include, but are not limited to, name, age, gender, physical attributes, location, registered contact number, family information, alternate contact number, registered e-mail address, or the like of the cardholders 104, etc.

The processing module 702 is configured to communicate with one or more remote devices, such as a remote device 708, using the communication module 706 over a network such as the network 116 of FIG. 1. Examples of the remote device 708 include the server system 200, the payment server 114, the acquirer server 108(1) or other computing systems of the issuer server 700. The communication module 706 is capable of facilitating such operative communication with the remote devices and cloud servers using API calls. The communication module 706 is configured to receive a payment transaction request performed by an account holder (e.g., the cardholder 104(1)) via the network 116. The processing module 702 receives payment card information, a payment transaction amount, cardholder information, and merchant information from the remote device 708 (e.g., the payment server 114). The issuer server 700 includes a transaction database 710 for storing transaction data. The transaction data may include, but is not limited to, transaction attributes, such as transaction amount, source of funds such as bank or credit cards, transaction channel used for loading funds such as the POS terminal or ATM machine, transaction velocity features such as count and transaction amount sent in the past x days to a particular account holder, transaction location information, external data sources, and other internal data to evaluate each transaction. The issuer server 700 includes a user profile database 712 storing user profiles associated with the plurality of account holders.

The user profile data may include an account balance, a credit line, details of the account holders, account identification information, payment card number, or the like. The details of the account holders (e.g., the plurality of cardholders 104(1)-104(N)) may include, but are not limited to, name, age, gender, physical attributes, location, registered contact number, family information, alternate contact number, registered e-mail address, or the like of the plurality of cardholders 104.

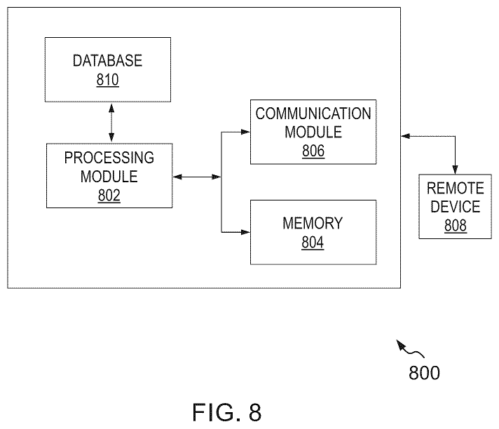

FIG. 8 illustrates a simplified block diagram of the payment server 800, in accordance with an embodiment of the present disclosure. The payment server 800 is an example of the payment server 114 of FIG. 1. The payment server 800 and the server system 200 may use the payment network 112 as a payment interchange network. Examples of payment interchange networks include, but are not limited to, Mastercard® payment system interchange network.

The payment server 800 includes a processing module 802 configured to extract programming instructions from a memory 804 to provide various features of the present disclosure. The components of the payment server 800 provided herein may not be exhaustive, and the payment server 800 may include more or fewer components than that depicted in FIG. 8. Further, two or more components may be embodied in one single component, and/or one component may be configured using multiple sub-components to achieve the desired functionalities. Some components of the payment server 800 may be configured using hardware elements, software elements, firmware elements, and/or a combination thereof.

Via a communication interface 806, the processing module 802 receives a request from a remote device 808, such as the issuer server 110(1), the acquirer server 108(1), or the server system 102. The request may be a request for conducting the payment transaction. The communication may be achieved through API calls without loss of generality. The payment server 800 includes a database 810. The database 810 also includes transaction processing data such as issuer ID, country code, acquirer ID, and Merchant Identifier (MID), among others.

When the payment server 800 receives a payment transaction request from the acquirer server 108(1) or a payment terminal (e.g., IoT device), the payment server 800 may route the payment transaction request to an issuer server (e.g., the issuer server 110(1)). The database 810 stores transaction identifiers for identifying transaction details, such as transaction amount, IoT device details, acquirer account information, transaction records, merchant account information, and the like.

In one example embodiment, the acquirer server 108(1) is configured to send an authorization request message to the payment server 800. The authorization request message includes, but is not limited to, the payment transaction request.

The processing module 802 further sends the payment transaction request to the issuer server 110(1) for facilitating the payment transactions from the remote device 808. The processing module 802 is further configured to notify the remote device 808 of the transaction status in the form of an authorization response message via the communication interface 806. The authorization response message includes, but is not limited to, a payment transaction response received from the issuer server 110(1). Alternatively, in one embodiment, the processing module 802 is configured to send an authorization response message for declining the payment transaction request via the communication interface 806 to the acquirer server 108(1). In one embodiment, the processing module 802 executes similar operations performed by the server system 200, however, for the sake of brevity, these operations are not explained herein.

The disclosed method with reference to FIG. 5, or one or more operations of the server system 200 may be implemented using software including computer-executable instructions stored on one or more computer-readable media (e.g., non-transitory computer-readable media, such as one or more optical media discs, volatile memory components (e.g., DRAM or SRAM), or nonvolatile memory or storage components (e.g., hard drives or solid-state nonvolatile memory components, such as Flash memory components) and executed on a computer (e.g., any suitable computer, such as a laptop computer, netbook, Web book, tablet computing device, smartphone, or other mobile computing devices). Such software may be executed, for example, on a single local computer or in a network environment (e.g., via the Internet, a wide-area network, a local-area network, a remote web-based server, a client-server network (such as a cloud computing network), or other such networks) using one or more network computers. Additionally, any of the intermediate or final data created and used during the implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such a suitable communication means includes, for example, the Internet, the World Wide Web (WWW), an intranet, software applications, cable (including fiber optic cable), magnetic communications, electromagnetic communications (including RF, microwave, and infrared communications), electronic communications, or other such communication means.

Although the invention has been described with reference to specific exemplary embodiments, it is noted that various modifications and changes may be made to these embodiments without departing from the broad spirit and scope of the invention. For example, the various operations, blocks, etc., described herein may be enabled and operated using hardware circuitry (for example, Complementary Metal Oxide Semiconductor (CMOS) based logic circuitry), firmware, software, and/or any combination of hardware, firmware, and/or software (for example, embodied in a machine-readable medium). For example, the apparatuses and methods may be embodied using transistors, logic gates, and electrical circuits (for example, Application Specific Integrated Circuit (ASIC) circuitry and/or Digital Signal Processor (DSP) circuitry).

Particularly, the server system 200 and its various components may be enabled using software and/or using transistors, logic gates, and electrical circuits (for example, integrated circuit circuitry such as ASIC circuitry). Various embodiments of the invention may include one or more computer programs stored or otherwise embodied on a computer-readable medium. Herein, the computer programs are configured to cause the processor or the computer to perform one or more operations. A computer-readable medium storing, embodying, or encoded with a computer program or similar language may be embodied as a tangible data storage device storing one or more software programs that are configured to cause the processor or computer to perform one or more operations. Such operations may be, for example, any of the steps or operations described herein. In some embodiments, the computer programs may be stored and provided to a computer using any type of non-transitory computer-readable media. Non-transitory computer-readable media includes any type of tangible storage media.

Examples of non-transitory computer-readable media include magnetic storage media (such as floppy disks, magnetic tapes, hard disk drives, etc.), optical magnetic storage media (e.g. magneto-optical disks), Compact Disc Read-Only Memory (CD-ROM), Compact Disc Recordable (CD-R), compact disc rewritable (CD-R/W), Digital Versatile Disc (DVD), BLU-RAY® Disc (BD), and semiconductor memories (such as mask ROM, programmable ROM (PROM), (erasable PROM), flash memory, Random Access Memory (RAM), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer-readable media. Examples of transitory computer-readable media include electric signals, optical signals, and electromagnetic waves. Transitory computer-readable media can provide the program to a computer via a wired communication line (e.g., electric wires and optical fibers) or a wireless communication line.

Various embodiments of the invention, as discussed above, may be practiced with steps and/or operations in a different order, and/or with hardware elements in configurations, which are different than those which are disclosed. Therefore, although the invention has been described based on these exemplary embodiments, it is noted that certain modifications, variations, and alternative constructions may be apparent and well within the spirit and scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A computer-implemented method comprising:
accessing, by a server system, a multi-partite sub-graph from a database associated with the server system, the multi-partite sub-graph comprising a central node connected with one or more leaf nodes through one or more paths, the central node belonging to a particular node set representing a particular entity set and the one or more leaf nodes belonging to a distinct node set representing a distinct entity set, each path is associated with a distinct relation type;
extracting, by the server system, a central node feature set associated with the central node and a leaf node feature set associated with each leaf node of the one or more leaf nodes from the multi-partite sub-graph;
determining, by a Machine Learning (ML) model associated with the server system, a first node representation for the central node based, at least in part, on the distinct relation type of each path, the central node feature set, and the leaf node feature set;
determining, by the server system, a second node representation for the central node based, at least in part, on concatenating individual path feature vectors of each path; and
determining, by the server system, a final node representation for the central node based, at least in part, on the first node representation and the second node representation.

2. The computer-implemented method as claimed in claim 1, wherein accessing the multi-partite sub-graph comprising:
accessing, by the server system, a multi-partite graph from the database, the multi-partite graph comprising a plurality of node sets corresponding to a plurality of entity sets and one or more edges, each node set comprising a plurality of nodes representing a plurality of entities of an entity set, each node being associated with a plurality of node-related features of an individual entity and an edge of the one or more edges indicating information related to a relationship between two distinct nodes connected by the edge; and
generating, by the server system, a multi-partite sub-graph from the multi-partite graph based, at least in part, on traversing the one or more edges from each node of the particular node set to one or more distinct nodes of the distinct node set.

3. The computer-implemented method as claimed in claim 2, wherein generating the multi-partite sub-graph comprising:
iteratively processing, by the server system, the multi-partite graph till each node of the multi-partite graph is traversed, wherein the processing comprises:
traversing the one or more edges of the multi-partite graph from a randomly selected starting node of the multi-partite graph for a predefined number of hops to determine the one or more paths, wherein the one or more paths indicate a k-hop relation between the central node and each leaf node, and the predefined number of hops indicates a number of the one or more edges present between the central node and the each leaf node, wherein the k indicates a natural number;
extracting the central node and the each leaf node connected by the one or more paths preserving a structure of the multi-partite graph, wherein the randomly selected starting node is the central node during the traversing step; and
randomly re-selecting another starting node from the plurality of node sets for next iteration, wherein the another starting node is distinct from the extracted central node.

4. The computer-implemented method as claimed in claim 2, further comprising:
performing, by the server system, for the each node of the each node set of the multi-partite graph:
determining a first label category count and a second label category count for an individual node based, at least in part, on the information associated with the one or more edges connected to the individual node, wherein the information for each edge of the one or more edges indicate whether a corresponding edge is associated with a first label category or a second label category; and
in response to determining that the first label category count is at least equal to a threshold percentage of a total edge count of the one or more edges, labeling the individual node with the first label category.

5. The computer-implemented method as claimed in claim 4, further comprising:
in response to determining that the second label category count is at least equal to the threshold percentage of the total edge count of the one or more edges, labeling the individual node with the second label category.

6. The computer-implemented method as claimed in claim 5, wherein the first label category is a fraudulent transaction, and the second label category is a non-fraudulent transaction.

7. The computer-implemented method as claimed in claim 1, further comprising:
receiving, by the server system, a prediction request for a down-stream task for an entity, wherein the entity is represented by the central node in the multi-partite sub-graph; and
generating, by a down-stream task prediction model, a prediction associated with the central node based, at least in part, on the final node representation for the central node.

8. The computer-implemented method as claimed in claim 1, wherein determining the first node representation comprises:
generating, by the server system, a central node representation for the central node based, at least in part, on the central node feature set;
generating, by the server system, a leaf node representation for the each leaf node of the one or more leaf nodes based, at least in part, on the leaf node feature set;
aggregating, by the server system, leaf node representation for the distinct relation type of each path based, at least in part, on the distinct relation type; and
generating, by the server system, the first node representation based, at least in part, on the central node representation and the aggregated leaf node representation.

9. The computer-implemented method as claimed in claim 1, further comprises:
training, by the server system, the ML model to compute the first node representation based, at least in part, on a set of operations until a predefined output is obtained, wherein the set of operations comprises:
initializing the ML model based, at least in part, on one or more ML model parameters, wherein the one or model parameters comprises a set of weights;
generating the first node representation based, at least in part, on the distinct relation type, the central node feature set, and the leaf node feature set;
computing loss function by comparing the first node representation with a true label; and
optimizing the set of weights based, at least in part, on the loss function.

10. The computer-implemented method as claimed in claim 1, wherein the server system is a payment server associated with a payment network.

11. A server system, comprising:
a communication interface;
a memory comprising executable instructions; and
a processor communicably coupled to the communication interface and the memory, the processor configured to cause the server system to at least:
access a multi-partite sub-graph from a database associated with the server system, the multi-partite sub-graph comprising a central node connected with one or more leaf nodes through one or more paths, the central node belonging to a particular node set representing a particular entity set and the one or more leaf nodes belonging to a distinct node set representing a distinct entity set, each path is associated with a distinct relation type;
extract central node feature set associated with the central node and a leaf node feature set associated with each leaf node of the one or more leaf nodes from the multi-partite sub-graph;
determine, by a Machine Learning (ML) model associated with the server system, a first node representation for the central node based, at least in part, on the distinct relation type of each path, the central node feature set, and the leaf node feature set;
determine a second node representation for the central node based, at least in part, on concatenating individual path feature vectors of each path; and
determine a final node representation for the central node based, at least in part, on the first node representation and the second node representation.

12. The server system as claimed in claim 11, to access the multi-partite sub-graph the server system is caused, at least in part, to:
access a multi-partite graph from the database, the multi-partite graph comprising a plurality of node sets corresponding to a plurality of entity sets and one or more edges, each node set comprising a plurality of nodes representing a plurality of entities of an entity set, each node being associated with a plurality of node-related features of an individual entity and an edge of the one or more edges indicating information related to a relationship between two distinct nodes connected by the edge; and
generate a multi-partite sub-graph from the multi-partite graph based, at least in part, on traversing the one or more edges from each node of the particular node set to one or more distinct nodes of the distinct node set.

13. The server system as claimed in claim 12, to generate the multi-partite sub-graph the server system is caused, at least in part, to:
iteratively process the multi-partite graph till each node of the multi-partite graph is traversed, wherein the processing comprises:
traverse the one or more edges of the multi-partite graph from a randomly selected starting node of the multi-partite graph for a predefined number of hops to determine the one or more paths, wherein the one or more paths indicates a k-hop relation between the central node and the each leaf node and the predefined number of hops indicates a number of the one or more edges present between the central node and the each leaf node, wherein k indicates a natural number;
extract the central node and the each leaf node connected by the one or more paths preserving a structure of the multi-partite graph, wherein the randomly selected starting node is the central node during the traversing step; and
randomly re-select another starting node from the plurality of node sets for next iteration, wherein the another starting node is distinct from the extracted central node.

14. The server system as claimed in claim 12, wherein the server system is further caused, at least in part, to:
perform for the each node of the each node set of the multi-partite graph:
determine a first label category count and a second label category count for an individual node based, at least in part, on the information associated with the one or more edges connected to the individual node, wherein the information for each edge of the one or more edges indicate whether a corresponding edge is associated with a first label category or a second label category; and
in response to determining that the first label category count is at least equal to a threshold percentage of a total edge count of the one or more edges, label the individual node with the first label category.

15. The server system as claimed in claim 14, wherein the server system is further caused, at least in part, to:
in response to determining that the second label category count is at least equal to the threshold percentage of the total edge count of the one or more edges, label the individual node with the second label category.

16. The server system as claimed in claim 15, wherein the first label category is a fraudulent transaction, and the second label category is a non-fraudulent transaction.

17. The server system as claimed in claim 11, wherein the server system is further caused, at least in part, to:
receive a prediction request for a down-stream task for an entity, wherein the entity is represented by the central node in the multi-partite sub-graph; and
generate, by a down-stream task prediction model, a prediction associated with the central node based, at least in part, on the final node representation for the central node.

18. The server system as claimed in claim 11, wherein to determine the first node representation the server system is further caused, at least in part, to:
generate a central node representation for the central node based, at least in part, on the central node feature set;
generate a leaf node representation for the each leaf node of the one or more leaf nodes based, at least in part, on the leaf node feature set;
aggregate leaf node representation for the distinct relation type based, at least in part, on the distinct relation type; and
generate the first node representation based, at least in part, on the central node representation and the aggregated leaf node representation.

19. The server system as claimed in claim 11, wherein the server system is further caused, at least in part, to:
train the ML model to compute the first node representation based, at least in part, on a set of operations until a predefined output is obtained, wherein the set of operations comprises:
initialize the ML model based, at least in part, on one or more ML model parameters, wherein the one or model parameters comprises a set of weights;
generate the first node representation based, at least in part, on the distinct relation type, the central node feature set, and the leaf node feature set;
compute loss function by comparing the first node representation with a true label; and
optimize the set of weights based, at least in part, on the loss function.

20. A non-transitory computer-readable storage medium comprising computer-executable instructions that, when executed by at least a processor of a server system, cause the server system to perform a method comprising:
accessing a multi-partite sub-graph from a database associated with the server system, the multi-partite sub-graph comprising a central node connected with one or more leaf nodes through one or more paths, the central node belonging to a particular node set representing a particular entity set and the one or more leaf nodes belonging to a distinct node set representing a distinct entity set, each path is associated with a distinct relation type;
extracting a central node feature set associated with the central node and a leaf node feature set associated with each leaf node of the one or more leaf nodes from the multi-partite sub-graph;
determining, by a Machine Learning (ML) model associated with the server system, a first node representation for the central node based, at least in part, on the distinct relation type of each path, the central node feature set, and the leaf node feature set;
determining a second node representation for the central node based, at least in part, on concatenating individual path feature vectors of each path; and
determining a final node representation for the central node based, at least in part, on the first node representation and the second node representation.
